(19) United States
(12) Patent Application Publication
(10) Pub. No.: US 2012/0087648 A1
(43) Pub. Date: Apr. 12, 2012

(54) METHOD AND SYSTEM FOR PROTECTION SWITCHING

(76) Inventors: Ke Qin Gao, Plano, TX (US); Nageswara Rao Nukala, Murphy, TX (US); Vikas Mittal, Richardson, TX (US); Malleswaraprasad Sunkara, Richardson, TX (US); Lixin Jia, Plano, TX (US); Quang Chan Tieu, Richardson, TX (US)

(21) Appl. No.: 12/902,827

(22) Filed: Oct. 12, 2010

(51) Int. Cl. G02F 1/00

(52) U.S. Cl. 398/1

(57) ABSTRACT

A method is provided for protection switching in an optical network. The method may include communicating a switch request for initiation of protection switching in response to a determination that at least a minimum frequency of interrupts indicating failure of an optical signal has occurred over a first period. The method may also include communicating a switch request for cessation of protection switching in response to a determination that no more than a maximum frequency of interrupts indicating failure of an optical signal has occurred over a second period.

### TECHNICAL FIELD OF THE INVENTION

The present invention relates generally to optical networks and, more particularly, to a method and system for protection switching in an optical system.

### BACKGROUND

Telecommunications systems, cable television systems and data communication networks use optical networks to rapidly convey large amounts of information between remote points. In an optical network, information is conveyed in the form of optical signals through optical fibers. Optical fibers comprise thin strands of glass capable of communicating the signals over long distances with very low loss.

To ensure high reliability and availability in optical communications networks, protection switching is often used. When implemented, protection switching typically provides a primary or “working” path for a network and a redundant or “protection” path for the network. Accordingly, each path may be monitored, and if a failure is detected on the working path, network traffic may be switched to the protection path. An example of protection switching may be Ethernet Linear Protection Switching (ELPS) as defined by the ITU G.8031 standard.

With protection switching, an optical signal may be transmitted via two or more optical paths between the same source and destination node. A selector at the destination may include a photodetector per each path to monitor signals received from the two or more paths. Based on such received signals, the selector may select one of the signals to be forwarded to a transponder or receiver at the destination node. For example, the selector may determine, based on the photodetector monitoring, whether one of the paths has experienced a loss of signal or “loss of light.” If a particular path experiences a loss of light, then the selector may select another path to forward to the transponder or receiver. Such selection may be referred to as a “protection switch.”

The selector may operate in accordance with a protection switching protocol (e.g., ITU G.8031 or other standard). Each protection switching protocol may include a hierarchy for handling user-initiated and auto-failure initiated protection switching requests. Such hierarchy may be implemented via hardware, software, or a combination thereof. If a portion of the hierarchy is implemented in software, then hardware must quickly notify software of any signal loss that has occurred or cleared as switching is a time-sensitive operation. Such notification is typically performed via interrupts.

Often, an optical signal entering the selector may be unstable, in that the signal failure occurs and clears rapidly and repeatedly. For example, while unstable a signal may fail and clear 20 times per second. This may lead to many interrupts being received by an interface layer in software, which are then translated to switch request messages for a switching engine. The switching engine may receive such requests and apply a switching hierarchy. Frequent switch requests can exhaust the resources available to the switching engine, and may cause software failure.

### SUMMARY

In accordance with a particular embodiment of the present disclosure, a method for protection switching in an optical network may include communicating a switch request for initiation of protection switching in response to a determination that at least a minimum frequency of interrupts indicating failure of an optical signal has occurred over a first period. The method may also include communicating a switch request for cessation of protection switching in response to a determination that no more than a maximum frequency of interrupts indicating failure of an optical signal has occurred over a second period.

Technical advantages of one or more embodiments of the present invention may provide a software-based solution to reduce the frequency of interrupts received by a switching element, thus potentially reducing processing required by a switching engine.

It will be understood that the various embodiments of the present invention may include some, all, or none of the enumerated technical advantages. In addition, other technical advantages of the present invention may be readily apparent to one skilled in the art from the figures, description and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating an example optical network, in accordance with certain embodiments of the present disclosure;

FIG. 2 is a block diagram illustrating an example stack for a decision module of a selector, in accordance with certain embodiments of the present disclosure; and

FIG. 3 is a block diagram illustrating a finite state machine implemented by an interface layer of software to reduce the frequency of switch requests to a switch engine implemented in software.

### DETAILED DESCRIPTION

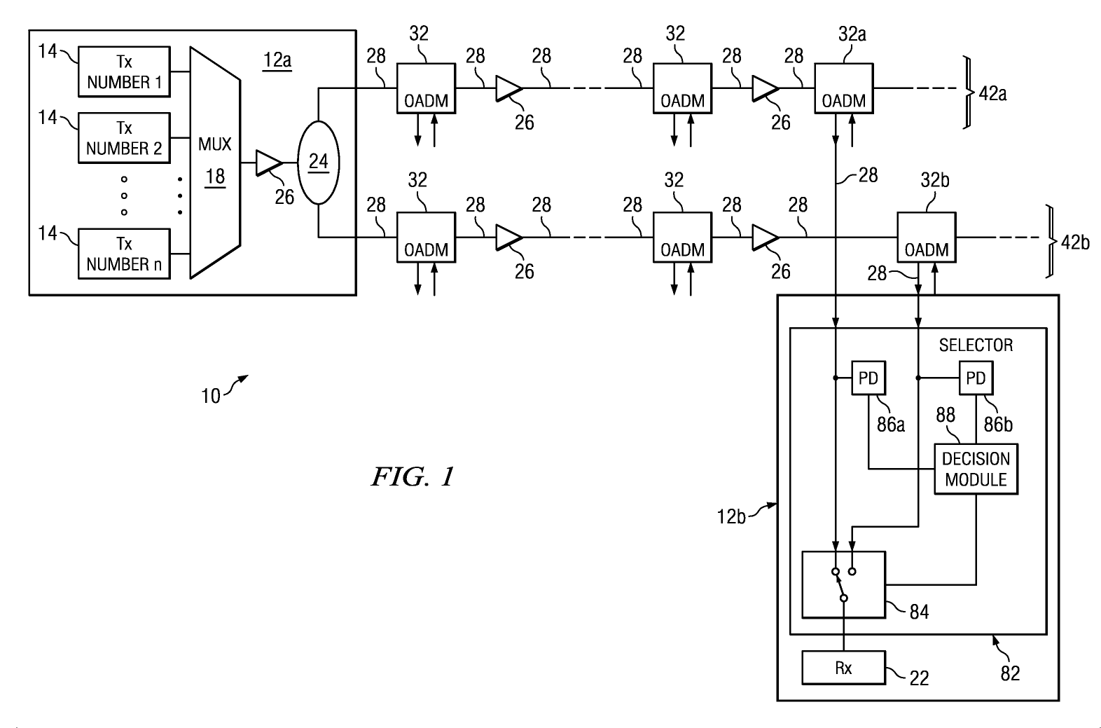

FIG. 1 illustrates an example optical network 10. Optical network 10 may include one or more optical fibers 28 operable to transport one or more optical signals communicated by components of the optical network 10. The components of optical network 10, coupled together by optical fiber 28, may include nodes 12a and 12b and one or more optical add/drop multiplexers (OADMs) 32. A node 12 and/or an OADM 32 may be generally referred to as a “network element.” Although the optical network 10 is shown as a point-to-point optical network with terminal nodes, the optical network 10 may also be configured as a ring optical network, a mesh optical network, or any other suitable optical network or combination of optical networks, and may include any number of nodes intermediate to nodes 12a and 12b. The optical network 10 may be used in a short-haul metropolitan network, a long-haul inter-city network, or any other suitable network or combination of networks.

A node 12 and/or OADM 32 may represent a Label Switching Router (LSR). One or more label switched paths (LSPs) including a sequence of nodes 12 and OADMs 32 may be established for routing packets throughout optical network 10. For example, traffic may travel from source node 12a, through zero, one, or more intermediate OADMs 32, to destination node 12b.

Node 12a may include transmitters 14, a multiplexer 18, an amplifier 26, and a splitter 24. Transmitters 14 may include any transmitter or other suitable device operable to transmit optical signals. Each transmitter 14 may be configured to receive information transmit a modulated optical signal at a certain wavelength. In optical networking, a wavelength of light is also referred to as a channel. Each transmitter 14 may also be configured to transmit this optically encoded information on the associated wavelength. The multiplexer 18 may include any multiplexer or combination of multiplexers or other devices operable to combine different channels into one signal. Multiplexer 18 may be configured to receive and combine the disparate channels transmitted by transmitters 14 into an optical signal for communication along fibers 28.

Amplifier 26 of node 12a may be used to amplify the multi-channeled signal. Amplifier 26 may be positioned before and/or after certain lengths of fiber 28. Amplifier 26 may comprise an optical repeater that amplifies the optical signal. This amplification may be performed without opto-electrical or electro-optical conversion. In particular embodiments, amplifier 26 may comprise an optical fiber doped with a rare-earth element. When a signal passes through the fiber, external energy may be applied to excite the atoms of the doped portion of the optical fiber, which increases the intensity of the optical signal. As an example, amplifier 26 may comprise an erbium-doped fiber amplifier (EDFA). However, any other suitable amplifier 26 may be used.

Splitter 24 may represent an optical coupler or any other suitable optical component operable to split an optical signal into multiple copies of the optical signal and transmit the copies to other components within network 10. In the illustrated embodiment, splitter 24 may receive a signal from amplifier 26 of node 12a and split the received traffic into two copies. One copy may be transmitted via path 42a, while the other copy may be transmitted over 42b, in order to provide redundancy protection for the signal, as described in greater detail below.

The process of communicating information at multiple channels of a single optical signal is referred to in optics as wavelength division multiplexing (WDM). Dense wavelength division multiplexing (DWDM) refers to the multiplexing of a larger (denser) number of wavelengths, usually greater than forty, into a fiber. WDM, DWDM, or other multi-wavelength transmission techniques are employed in optical networks to increase the aggregate bandwidth per optical fiber. Without WDM or DWDM, the bandwidth in networks would be limited to the bit rate of solely one wavelength. With more bandwidth, optical networks are capable of transmitting greater amounts of information. Referring back to FIG. 1, node 12a in optical network 10 may be configured to transmit and multiplex disparate channels using WDM, DWDM, or some other suitable multi-channel multiplexing technique, and to amplify the multi-channel signal.

As discussed above, the amount of information that can be transmitted over an optical network varies directly with the number of optical channels coded with information and multiplexed into one signal. Therefore, an optical signal employing WDM may carry more information than an optical signal carrying information over solely one channel. An optical signal employing DWDM may carry even more information.

After the multi-channel signal is transmitted from node 12a, the signal may travel over one or more paths 42 (e.g., paths 42a and 42b) to node 12b. Each path 42 may include one or more OADMs 32, one or more amplifiers 26, and one or more fibers 28 coupling such OADMs 32 and amplifiers 26.

An OADM 32 may include any multiplexer or combination of multiplexers or other devices operable to combine different channels into one signal. An OADM 32 may be operable to receive and combine the disparate channels transmitted across optical network 10 into an optical signal for communication along fibers 28. In addition, an OADMs 32 comprise an add/drop module, which may include any device or combination of devices operable to add and/or drop optical signals from fibers 28. An OADM 32 may be coupled to an amplifier 26 which may be used to amplify a WDM and/or DWDM signal as it travels through the optical network 10. After a signal passes through an OADM 32, the signal may travel along fibers 28 directly to a destination, or the signal may be passed through one or more additional OADMs 32 before reaching a destination.

Similar to amplifier 26 of node 12a, other amplifiers 26 or optical network 10 may be used to amplify the multi-channeled signal communicated by OADMs 32. Amplifiers 26 may be positioned before and/or after certain lengths of fiber 28. Amplifiers 26 may comprise an optical repeater that amplifies the optical signal. This amplification may be performed without opto-electrical or electro-optical conversion. In particular embodiments, amplifiers 26 may comprise an optical fiber doped with a rare-earth element. When a signal passes through the fiber, external energy may be applied to excite the atoms of the doped portion of the optical fiber, which increases the intensity of the optical signal. As an example, amplifiers 26 may comprise an erbium-doped fiber amplifier (EDFA). However, any other suitable amplifiers 26 may be used.

An optical fiber 28 may include, as appropriate, a single, unidirectional fiber; a single, bi-directional fiber; or a plurality of uni- or bi-directional fibers. Although this description focuses, for the sake of simplicity, on an embodiment of the optical network 10 that supports unidirectional traffic, the present invention further contemplates a bi-directional system that includes appropriately modified embodiments of the components described below to support the transmission of information in opposite directions along the optical network 10. Furthermore, as is discussed in more detail below, the fibers 28 may be high chromatic dispersion fibers (as an example only, standard single mode fiber (SSMF) or non-dispersion shifted fiber (NDSF)), low chromatic dispersion fibers (as an example only, non zero-dispersion-shifted fiber (NZ-DSF), such as E-LEAF fiber), or any other suitable fiber types.

Node 12b may be configured to receive signals transmitted over optical network 10. For example, as shown in FIG. 1, a portion of the multi-channel signal through path 42a may be dropped to node 12b by OADM 32a, and a portion of the multi-channel signal through path 42b may be dropped to node 12b by OADM 32b. Node 12b may include a selector 82 and a receiver 22. Selector 82 may be configured to receive at least a portion of the multi-channel signal from each of path 42a and 42b and selects which of the two signals to pass to receiver 22. Such selection may be made on any suitable criteria, including bit error rate and/or power levels of the individual signals.

Selector 82 may include a photodetector 86 (e.g., photodetectors 86a and 86b) associated with each path 42, a decision module 88, and a switch 84. A photodetector 86 may be any system, device or apparatus configured to detect an intensity of light and convert such detected intensity into an electrical signal indicative of such intensity. Such electrical signals from photodetectors 86 may be communicated to decision module 88. Based on analysis of the electrical signals from photodetectors 86, decision module 88 may determine whether to pass the signal dropped from path 42a or the signal dropped from path 42b. A signal indicative of such determination may be communicated from decision module 88 to switch 84, and switch 84 may pass either the signal from path 42a or the signal from path 42b to receiver 22 based on the signal received from decision module 88. For example, decision module 88 may be configured such that the signal received from path 42a is passed to receiver 22 unless the intensity of signal received via path 42a falls below a particular threshold relative to a baseline power level (thus indicating a loss of light condition), in which case switch 84 may protection switch such that the signal received via path 42b is passed to receiver 22.

Receiver 22 may include any receiver or other suitable device operable to receive an optical signal. Receiver 22 may be configured to receive one or more channels of an optical signal carrying encoded information and demodulate the information into an electrical signal.

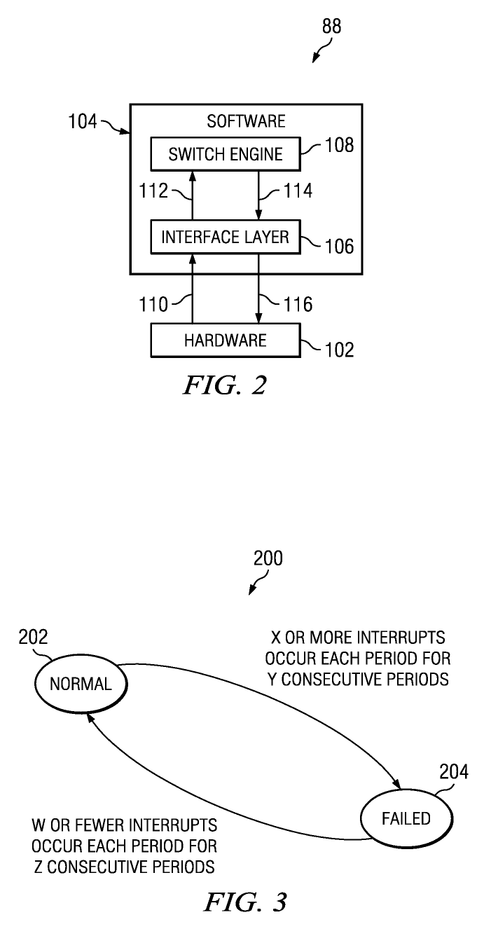

FIG. 2 is a block diagram illustrating an example stack for decision module 88 of selector 82, in accordance with certain embodiments of the present disclosure. As shown in FIG. 2, decision module 82 may include hardware 102 and software 104. Hardware 102 of decision module 88 may be communicatively coupled to photodetectors 86 and based on signals received from photodetectors 86, may communicate an interrupt 110 to software 104. Such interrupt may indicate a failure of an optical signal received at a photodetector 86, or a clearing of such failure.

Software 104 may include a program of instructions carried on a computer-readable medium and executable by a processor, the program of instructions operable to, when executed, carry out the functionality described herein. As shown in FIG. 2, software 104 may include interface later 106 and switch engine 108. Interface layer 106 may be a software abstraction layer that translates commands, messages, and requests between switch engine 108 and hardware 102. Interface layer 106 may receive an interrupt 110 from hardware 102 and translate interrupt 110 to a switch request message 112 for switch engine 108.

Switch engine 108 may be configured to receive switch request messages 112 and based on such messages and a protection switching hierarchy (e.g., ITU G.8031 or other standard) may generate a switching command 114 to be communicated to interface layer, which interface layer may translate and forward as switching command 116 to hardware 102, such switching command 116 ultimately destined for switch 84.

As mentioned previously, an optical signal entering selector 82 may be unstable, in that the signal failure occurs and clears rapidly and repeatedly. This may lead to many interrupts 110 being received by interface layer 106 and many switch requests 112 being processed by switching engine 108. These frequent switch requests 112 can exhaust the resources available the switching engine 108, possibly leading to failure of software 104 or other undesirable effects.

To prevent such frequent switch requests 112, interface layer 106 may implement a state machine such that translates an interrupt 110 into a switch request 112 indicating failure to switching engine 108 only upon receipt of at least a minimum frequency of interrupts 110 over a particular period, and may communicate a switch request 112 indicating clearance of a failure to switching engine 108 only upon receipt of nor more than a maximum frequency of interrupts 110 over another particular period. Finite state machine 200 of FIG. 3 illustrates such a state machine.

At state 202, state machine 200 is in a normal state in which no failure exists (e.g., selector 82 selects working path). While in state 202, if interface layer 106 receives a minimum number of interrupts (e.g., X or more) for each polling interval (e.g., T1) for a particular number (e.g., Y) of consecutive polling periods, interface layer 106 may transition state machine 200 to state 204, wherein state 204 indicates a failed state. In connection with transitioning to state 204, interface layer 106 may communicate a switch request 112 to switch engine 108 indicating a failure. In response to the switch request 112, switch engine 108 may initiate protection switching for node 12b (e.g., switch from working path 42a to protection path 42b). The minimum number of interrupts (X), polling interval (T1), and/or the number of polling intervals (Y) may be set to any appropriate value(s). Such values may be set automatically or manually, and may be determined by a manufacturer, user, administrator, and/or other suitable person. As a specific example, the polling interval T1 may be set to 500 ms. As another specific example, the number of polling intervals may be set to 20.

While in state 204, if interface layer 106 receives a maximum number of interrupts or fewer (e.g., W or fewer) for each polling interval (e.g., T2) for a particular number (e.g., Z) of consecutive polling periods, interface layer 106 may transition state machine 200 to state 202. In connection with transitioning to state 202, interface layer 106 may communicate a switch request 112 to switch engine 108 indicating clearance of a failure. In response to the switch request 112, switch engine 108 may cease protection switching for node 12b (e.g., switch from protection path 42b to working path 42a). The maximum number of interrupts (W), polling interval (T2), and/or the number of polling intervals (Z) may be set to any appropriate value(s). Such values may be set automatically or manually, and may be determined by a manufacturer, user, administrator, and/or other suitable person. In certain embodiments, the maximum number of interrupts W may be zero. In these and other embodiments the polling interval T2 may be equal to the polling interval T1. In the same or alternative embodiments, the number of polling intervals Z may be equal to the number of polling intervals Y.

A component of optical network 10 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible computer readable storage media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to optical network 10 without departing from the scope of the invention. The components of optical network 10 may be integrated or separated. Moreover, the operations of optical network 10 may be performed by more, fewer, or other components. Additionally, operations of optical network 10 may be performed using any suitable logic. As used in this document, “each” refers to each member of a set or each member of a subset of a set.

Although the present invention has been described with several embodiments, various changes and modifications may be suggested to one skilled in the art. It is intended that the present invention encompass such changes and modifications as fall within the scope of the appended claims.

What is claimed is:

1. A method for protection switching in an optical network, comprising:
communicating a switch request for initiation of protection switching in response to a determination that at least a minimum frequency of interrupts indicating failure of an optical signal has occurred over a first period; and
communicating a switch request for cessation of protection switching in response to a determination that no more than a maximum frequency of interrupts indicating failure of an optical signal has occurred over a second period.

2. A method according to claim 1, wherein the first period is approximately equal to the second period.

3. A method according to claim 1, wherein determining whether at least the minimum frequency of interrupts has occurred comprises determining whether a minimum number of interrupts have been received for each polling interval for a particular number of consecutive polling periods.

4. A method according to claim 1, wherein determining whether nor more than the maximum frequency of interrupts has occurred comprises determining whether a maximum number of interrupts have been received for each polling interval for a particular number of consecutive polling periods.

5. A selector, comprising:
a first photodetector configured to be communicatively coupled to the first path and determine a first signal intensity of a first optical signal of the first path;
a second photodetector configured to be communicatively coupled to the second path and determine a second signal intensity of a second optical signal of the second path;
a switch configured to be communicatively coupled to a receiver and communicatively coupled to the first path and a second path in an optical network, the switch configured to pass one of the first optical signal and the second optical signal;
a decision module comprising:
hardware communicatively coupled to the switch and communicatively coupled to the first photodetector and the second photodetector, the hardware configured to communicate one or more interrupts indicating failure of the first path based on at least one of the first signal intensity and the second signal intensity; and
software embodied in computer-readable media, the software comprising:
an interface layer configured to, when executed:
in response to a determination that at least a minimum frequency of interrupts has occurred over a first period, communicating a first switch request; and
in response to a determination that no more than a maximum frequency of interrupts has occurred over a second period, communicate a second switch request; and
a switching engine configured to, when executed:
in response to receiving the first switch request, communicating a first switching signal to the switch such that the switch passes the first optical signal; and
in response to receiving the second switch request, communicating a second switching signal to the switch such that the switch passes the second optical signal.

6. A selector according to claim 5, wherein the first period is approximately equal to the second period.

7. A selector according to claim 5, the interface layer further configured to, when executed, determine whether a minimum number of interrupts have been received for each polling interval for a particular number of consecutive polling periods in order to determining whether at least the minimum frequency of interrupts has occurred.

8. A selector according to claim 5, the interface layer further configured to, when executed, determine whether a maximum number of interrupts have been received for each polling interval for a particular number of consecutive polling periods in order to determine whether nor more than the maximum frequency of interrupts has occurred comprises.

9. A network element, comprising:
a selector comprising:
a first photodetector configured to be communicatively coupled to the first path and determine a first signal intensity of a first optical signal of the first path;
a second photodetector configured to be communicatively coupled to the second path and determine a second signal intensity of a second optical signal of the second path;
a switch configured to be communicatively coupled to the first path and a second path in an optical network, the switch configured to pass one of the first optical signal and the second optical signal;
a decision module comprising:
hardware communicatively coupled to the switch and communicatively coupled to the first photodetector and the second photodetector, the hardware configured to communicate one or more interrupts indicating failure of the first path based on at least one of the first signal intensity and the second signal intensity; and
software embodied in computer-readable media, the software comprising:
an interface layer configured to, when executed:
in response to a determination that at least a minimum frequency of interrupts has occurred over a first period, communicating a first switch request; and
in response to a determination that no more than a maximum frequency of interrupts has occurred over a second period, communicate a second switch request; and
a switching engine configured to, when executed:
in response to receiving the first switch request, communicating a first switching signal to the switch such that the switch passes the first optical signal; and
in response to receiving the second switch request, communicating a second switching signal to the switch such that the switch passes the second optical signal; and
a receiver communicatively coupled to the switch and configured to receive the optical signal passed by the switch and demodulate information carried in the optical signal passed by the switch into an electrical signal.

10. A network element according to claim 9, wherein the first period is approximately equal to the second period.

11. A network element according to claim 9, the interface layer further configured to, when executed, determine whether a minimum number of interrupts have been received for each polling interval for a particular number of consecutive polling periods in order to determining whether at least the minimum frequency of interrupts has occurred.

12. A network element according to claim 9, the interface layer further configured to, when executed, determine whether a maximum number of interrupts have been received for each polling interval for a particular number of consecutive polling periods in order to determine whether nor more than the maximum frequency of interrupts has occurred comprises.
